(19) United States
(12) Patent Application Publication
(10) Pub. No.: US 2025/0005488 A1
(43) Pub. Date: Jan. 2, 2025

(54) Security Focused Governance, Risk, and Compliance Platform

(71) Applicant: Michael Lee Meline, JR., Hayden, ID (US)

(72) Inventor: Michael Lee Meline, JR., Hayden, ID (US)

(21) Appl. No.: 18/342,870

(22) Filed: Jun. 28, 2023

(51) Int. Cl. G06Q 10/0635; G06Q 10/0637

(52) U.S. Cl. CPC G06Q 10/0635; G06Q 10/06375

(57) ABSTRACT

A governance, risk, and compliance (GRC) platform that is all-inclusive and that utilizes the attributes of assets to drive activities and manage risk. The platform includes risk mapping and cost analysis for applications, vendor risk analysis, business continuity, disaster recovery, incident response, policy management, and evidence collection. The platform utilizes questionnaires and vulnerability scans to evaluate risk and compliance.

### FIELD OF THE INVENTION

The present invention relates generally to cyber security. The present invention related more specifically to risk and compliance analysis in a holistic manner.

### BACKGROUND OF THE INVENTION

Many companies are required to comply with a variety of governmental and industry regulations and guidelines. A company must continually audit its systems to ensure compliance with the regulations. Separately, the company must monitor cybersecurity risk and manage such risk. Each of these tasks is very burdensome of the company and requires the company to maintain a skillset that is difficult to find and maintain.

It is an objective of the present invention to provide an all-in-one solution for assessing governance, risk, and compliance (GRC) in a holistic manner. It an objective of the present invention to produce a management package for identifying and monitoring compliance and risk.

### SUMMARY OF THE INVENTION

A governance, risk, and compliance (GRC) platform that enables management to identify and manage all cybersecurity risk. The platform includes risk mapping and cost analysis for applications, vendor risk analysis, business continuity, disaster recovery, incident response, policy management, and evidence collection. The platform utilizes questionnaires and vulnerability scans to evaluate risk and compliance. The platform generates an audit metadata report. The platform maps evaluation tools to the application being evaluated. The platform identifies and manages risk from the inception of the causation of the risk through the appropriate management of the risk. This process goes beyond current capabilities, as it enables the company to identify and map risk throughout the lifecycle of risk and utilizes pieces of information gathered from a wide range of activities to build a comprehensive profile of the risks affecting the company.

This platform goes further in enabling the company to audit and create action plans that directly impact the identified risks, allowing the appropriate responses to the risks. The platform allows for external audit of the controls, allows the auditor to identify areas of concern and provides a means for the company to implement action plans. There are no known platforms that take this granular and comprehensive approach to cybersecurity risk.

### BRIEF DESCRIPTION OF THE DRAWINGS

FIG. 1 is a flowchart of Embodiment 1 of the present invention.

FIG. 2 is a block diagram of Embodiment 1 of the present invention.

FIG. 3 is a block diagram of Embodiment 1 of the present invention.

FIG. 4 is a diagram of Embodiment 2 of the present invention.

FIG. 5 is a diagram of Embodiment 2 of the present invention.

FIG. 6 is a diagram of Embodiment 2 of the present invention.

### DETAILED DESCRIPTION OF THE INVENTION

All illustrations of the drawings are for the purpose of describing selected versions of the present invention and are not intended to limit the scope of the present invention.

The present invention provides a wizard-driven question and answer system to determine risk. The present invention provides the ability to import a vulnerability scan with smart mapping, including a comparison against an application list, a comparison of operating systems, and the ability to select and modify findings. The present invention produces a reporting package, including charts and a written risk report. The present invention provides the ability to manage policies, including assignment of responsible parties, change controls, and “find: replace” customer information. The present invention provides the ability to generate an action plan. The present invention provides the ability to assign risk, quick selection or risk mitigation techniques, and customizable risk definitions. The present invention provides a co-branding opportunity. The present invention provides the capability to attach or upload evidence for all findings. The present invention provides the ability to assign role-based access controls. The present invention provides the ability to assign specific items to specific people or departments, such as a human resources department. The present invention takes a unique approach to risk management by interrelating the attributes of assets and utilizing these attributes to drive other actions such as change control, disaster recovery, etc. The present invention provides auditor access, which is view only. The present invention also provides administrator access. The administrator access allows the administrator to create questions, set default answers and risk, and create new customer profiles, including a risk default template, policy mapping, control to standard mapping, and import vulnerability scans with intelligent mapping.

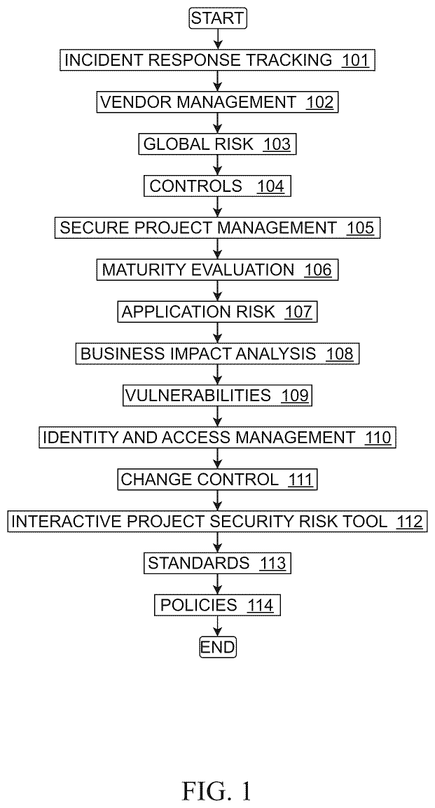

FIG. 1 shows a flowchart 100 of Embodiment 1 of the present invention.

At step 101, the platform tracks the incident response. The platform tracks the issue start time and date, the issue end date and time, the person reporting the incident, a descriptive issue title, an issue summary, the primary system affected, any secondary systems affected, participants in the security risk tool (SRT), the vendors involved, the incident owner, the incident commander, the impacted users, the preliminary cause of the issue, the incident severity, the number of company users affected, and the number of customers affected. The platform also tracks any third party persons or companies engaged in the recovery and/or investigation of the issue, including the name of the company, the name of the people, as well as their phone numbers, email addresses, and physical address. The platform also tracks a description of any communications from a suspected attacker, any indications of the event, whether data has been stolen or held for ransom, and whether malware was used. If a hacker was involved, the platform tracks how many systems were compromised, which systems were compromised, how many records were compromised, and what types of data were compromised. The platform tracks whether credentials were stolen. If credentials were stolen, the platform tracks how many credentials were stolen, which credentials were stolen, and whether any credentials have been changed. The platform tracks whether the system in still at risk and describes the reason for the continued risk. The platform tracks who is involved in the recovery process, the resolution steps, any workarounds used, and a detailed timeline of events. The platform tracks a detailed log of communications with law enforcement and regulatory agencies, including with agencies were notified, which specific agents were contacted, and how the agencies were notified. The platform tracks tasks for follow-up. Each task includes a task name, task description, the owner of the task, a target date for completion of the task, an actual completion date of the task, task completion notes, and an evaluation of whether the task was effective. The platform tracks the root cause of the issue and what lessons were learned from the issue. The platform tracks any notifications that were made, including who was notified, when the notification was made, a description of the notification, and whether all legally required notification were made. The platform tracks a description of all systems that were breached and all records stolen or potentially stolen, as well as whether the data were backed up. The platform attaches all appropriate logs.

At step 102, the platform manages vendors. Many companies hire third party organizations to manage risk of vendors. This is generally a cumbersome task and one that leads to a significant amount of work for the vendor, the third party company, and the company hiring the vendor. Vendor risk is one of the more significant risks in the organization. This process provides an approach that has been streamlined and that integrates with the holistic risk of the organization.

At step 103, the platform assesses global risk. The platform provides an understanding of how all of the risks combine to build a risk portfolio for the company, allowing the company to determine which risks would provide the best cost-benefit for management. Data are displayed in interactive dashboards. Global risk identifies the less specific risks and concentrates on the organization, as a whole.

At step 104, the platform manages controls. The platform allows a user to select or add controls. Most companies invest in a range of overlapping controls. This system helps to minimize the overlapping controls and streamline their approach to the controls necessary to mitigate risk. Control options include the title, changing the title, changing the description, changing the start date, changing the start time, changing the end date, and changing the end time. Addition control options include whether an outage is expected, what the expected outage duration is, change priority, brief description of what is driving the priority, standard operating procedures for the change, the specific procedures that will be used for the change, risk, affected applications, all systems affected by the change, anticipated interruption. The controls also include describing any communications that have gone out concerning the change, describing the interruption of business, helpdesk ticket numbers. Question control options include “Please answer all of the questions in the applications list; if they have been previously evaluated, please change them to ensure that the answers are correct and that the changes have been documented in the applications list. Have you done this?”, “Please describe the procedures that will be used, if the change fails; to immediately bring systems back online.”, Please describe the process you used to test the change, its effectiveness, and any failures or successes during the testing.”, “Please list the names of the business unit leaders you have communicated with and any concerns they had regarding the change.”, and “What user groups will be affected?” The controls also include the item type and path. A very unique attribute of this process is that it allows the user to identify the controls that provide the best cost-benefit analysis.

At step 105, the platform manages secure projects. Projects present another major risk to any company. Generally, cybersecurity and associated risks are an afterthought. This platform manages the risks associated with projects from the initial thought through to a finished project. It enables the organization to identify areas of concern, manage the concerns, and implement the appropriate controls. This is also necessary for cybersecurity certifications, to show a formal process for the identification, evaluation, and management of risk.

At step 106, the platform evaluates maturity. Companies struggle to understand how to prioritize their expenditures and resources (including time) for cybersecurity. They also need to understand how mature they are in any given area. This platform provides them with a clear understanding of where they lack maturity, so they can prioritize funds and efforts.

At step 107, the platform assesses application risk. The platform evaluates confidentiality, integrity, availability, compliance and business risk (CIACB), which is highly unique to this invention. The platform presents a series of questions to assess the application risk. The questions include: “Please list the name that is used by the vendor/designer to describe this system/application,” “Please list the department accountable for this application,” “Please describe the processes supported by this application/system,” “Please list the vendors who access, support, create, or repair this system and their associated roles,” “List other names used to describe this application/system,” “Where is the system located?”, “Describe the system/device. What does it do?”, “What is the product version?”, “How critical is the system?”, “Select the importance of this equipment/system,” “Who are the primary users of this equipment? Which department(s) use it most?”, “What are the primary hours this device/system is/are in operation?”, “List the recommended downtime Windows,” “What protocols are used? List the Protocol,” “Are the protocols appropriately secured?”, “Describe the manner in which this device connects to the Network,” “Describe the data at rest encryption technology (how is data on the device encrypted?),” “What Operating System (OS) does the system use?”, “Describe the patching Process,” “Screen/session Locking: how often does the screen/session lock?”, “Describe the data destruction process. When it leaves our facility, how is our data removed?”, “List any anti-theft Theft Protections,” “Describe documented Operating Procedures,” “Describe separation of Duties processes,” “Describe any shared access accounts. Please do not list any passwords. Please list the account name and the reason it is shared,” “Describe non-Company access to application/system/device,” “Describe any malicious code controls (Malware protections)” “Please describe the back-up process. Are regular back-ups being done? How often are they done? Are the back-up media periodically tested?”, “Does this system use any removable media? If so, are the media encrypted? If so, please describe,” “Does this system/equipment create audit logs?”, “Is the application up to date?”, “Please select the Confidential Data processed, stored, or transmitted on or through this system,” “Does the system transmit, store, or process Confidential data,” “Who monitors Audit Logs,” “If this software or device is not functional, what is the manual process for ensuring that the job it performs can still be done?”, “What kinds of controls are in place to ensure that the system is functional in the event of a disaster? Describe all testing and the frequency of testing,” “How often is maintenance performed?”, “When changes are made to the system, do they go through a change control process?”, Has the organization planned for storage requirements?”, “What is the Authentication Method?”, “Does this Application require Two Factor Authentication?”, “Does the authentication Meet our Security Requirements?”, “How often should access rights be reviewed?”, “How do we ensure that terminated employees are removed from the system?”, “Does the system/device validate input and prevent inappropriate input?”, “Is there an established test environment?”, “Do we test changes or conduct any other tests using live data,” “Does the device connect to more than one network at a time (also known as dual homing)?”, “Can we run a vulnerability test against it?”, “Please list all dependencies,” “Who is the business owner? (Typically responsible for budgeting for this device!),” “Who are the technical owners? (Typically responsible for repairing, backing up, and updating the device/system),” “Item Type,” and “Path”.

At step 108, the platform performs a business impact analysis (BIA). The platform categorizes risk based on BIA scoring. This is a task that is difficult for companies, as the methodologies for understanding the priorities and the impact of an event takes a large amount of analysis. This platform has simple questions that are scored and provide a clear understanding of the impact to the business. A higher concern application results in a higher risk scale. The platform presents a series of questions to analyze the business impact. The questions include: “Business Process Name,” “Business Process Description,” “Business Process Dependencies,” “Business Process Owner,” “Business Process Location,” “Please describe the impact of not having this business process available for a day; from a customer perspective,” “Please describe the impact of not having this business process available for a day; from a staffing perspective,” “Please describe the impact of not having this business process available for a day; from a Legal & Compliance perspective,” “Please describe the impact of not having this business process available for a day; from a Reputational Damage perspective,” “Please describe the impact of not having this business process available for a day; from a Financial Impact perspective,” “Please describe the impact of not having this business process available for a week; from a staffing perspective,” “Please describe the impact of not having this business process available for a week; from a customer perspective,” “Please describe the impact of not having this business process available for a week; from a Legal & Compliance perspective,” “Please describe the impact of not having this business process available for a week; from a Reputational Damage perspective,” “Please describe the impact of not having this business process available for a week; from a Financial Impact perspective,” “Please describe the impact of not having this business process available for a month; from a staffing perspective,” “Please describe the impact of not having this business process available for a month; from a customer perspective,” “Please describe the impact of not having this business process available for a month; from a Legal & Compliance perspective,” “Please describe the impact of not having this business process available for a month; from a Reputational Damage perspective,” “Please describe the impact of not having this business process available for a month; from a Financial Impact perspective,” “Work backlog,” “Alternate Business Process,” “Describe the alternate business process,” “Reporting requirements,” “Difficulty of recovery,” “Maximum allowable downtime,” “Minimum required staffing,” “Comments,” “Maximum data loss (Recovery Point Objective),” “Calculations 1d customer,” “Calculations 1d financial,” “Calculations 1d staff,” “Calculations 1d Legal,” “Calculations 1d Reputation,” “Calculations 1w customer,” “Calculations 1w financial,” “Calculations 1w staff,” “Calculations 1w Reputation,” “Calculations 1w Legal,” “Calculations 1m customer,” “Calculations 1m financial,” “Calculations 1m staff,” “Calculations Im Legal,” “Calculations Im Reputation,” “Recovery Time Objective (RTO),” “About the person completing the survey,” “Please enter your E-Mail address,” “Please enter your phone number,” “Operating Procedures and emergency operating procedures,” “Item Type,” “and Path.”

At step 109, the platform identifies vulnerabilities. The platform scans for vulnerabilities and maps the risks. Identifying vulnerabilities includes comparing the application against an application risk, comparing the operating system, providing an ability to select and modify the findings. Many platforms allow for the importation of vulnerabilities. This platform is unique in that it brings the vulnerabilities into the holistic system that works with the other modules to provide a much wider understanding of the organization, their assets, and the risks associated across the enterprise.

At step 110, the platform evaluates identify and access management (IAM). Evaluation factors include position, application, permissions, date last audited, person conducting the review, separation of duties validated, whether IAM access is appropriate for the system, comments, and item type. There are whole systems dedicated to IAM. This platform integrates a process that works with other modules to maintain checks and balances. These checks and balances are integrated with other areas and provide a much more clear methodology of comprehensive risk management; in this case, through managing access controls.

At step 111, the platform manages change control. Most organizations struggle to manage changes to the environment including process, system, and other changes that greatly impact the overall risk of the company. This section allows the company to manage the changes in a manner that is controlled and formally approved by those who should be in the approval roles.

At step 112, the platform operates an interactive project security risk tool (SRT). The company can utilize the tools in the platform to add various controls and determine the amount of risk the control(s) will mitigate. With limited budgets, the company can determine which controls will provide the best cost-benefit to the company.

At step 113, the platform evaluates standards. Standards and audit guidelines are a nightmare for many companies. Companies require comprehensive audits and they struggle to identify the requirements necessary to ensure a successful audit. This module allows the company to use a wizard driven questionnaire to track areas of compliance and non-compliance. It provides them with a clear picture of what would be necessary to meet the requirements of whichever standard they are trying to adhere to. I also allows for them to evaluate against a standards that they may use in the future.

At step 114, the platform evaluates policies. The platform links to specific language in the policy from the control evidence.

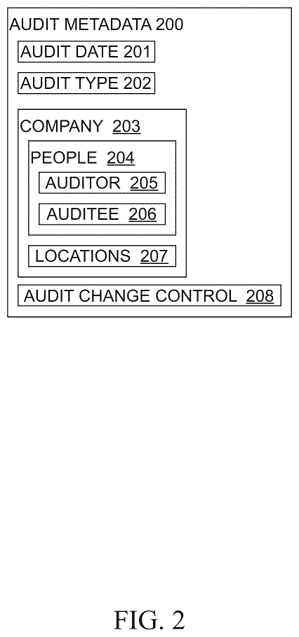

FIG. 2 is a block diagram of an audit metadata report 200 produced by Embodiment 1 of the present invention. The audit metadata 200 includes the audit date 201 and the audit type 202. The audit metadata 200 includes information about the company 203, including the people 204 and locations 207. The information about the people 204 further includes the identities of the auditor 205 and the auditee 206. Additionally, the audit metadata 200 includes a history of audit change controls 208.

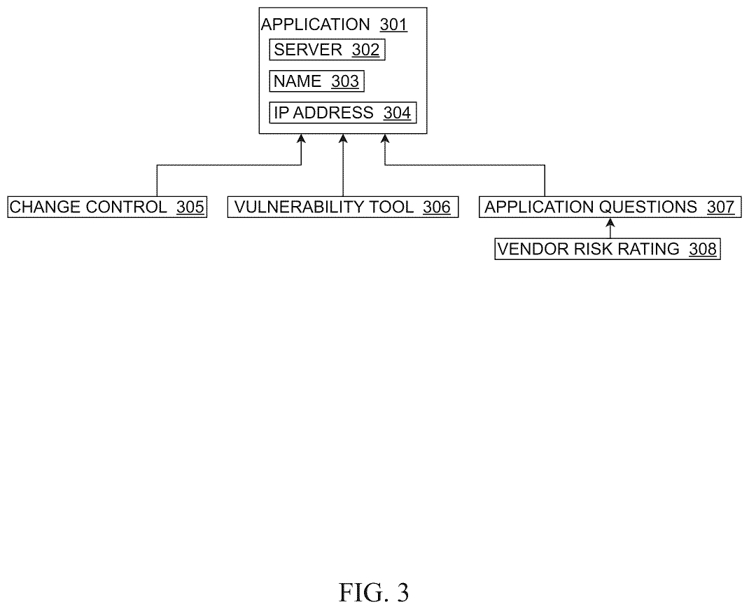

FIG. 3 is a block diagram of an application map of Embodiment 1 of the present invention. The platform maps application 301, including the server 302 on which the application 301 runs, the name 303 of the application 301, and the IP address 304 of the server 302. The map includes changes control 305 connected to the application 301, the vulnerability tool 306 used to assess the application 301, and the application questions 307. The set of application questions 307 presented is based on the vendor risk rating 308. The application 301 is risk rated based on the data stored, the vendor rating 308, and the application questions 307. A vulnerability scan is run, and the platform shows the risk associated with the server risk, combined with the importance of the application, the number of records, and the risk of compromise through vulnerabilities. The platform presents the vulnerabilities in a table, such as Table 1.

TABLE 1
Application Vulnerability and Overall Risk

| | | Product IP | Database | Test IP | | Overall |
|---|---|---|---|---|---|---|
| Application | Records | Address | IP Address | Address | Vulnerabilities | Risk |
| App A | 100,000 | 10.1.1.1 | 10.1.1.2 | 10.1.2.3 | Critical | Critical |
| App X | 5 | 10.1.1.1 | 10.1.1.2 | 10.1.2.3 | Critical | Low |

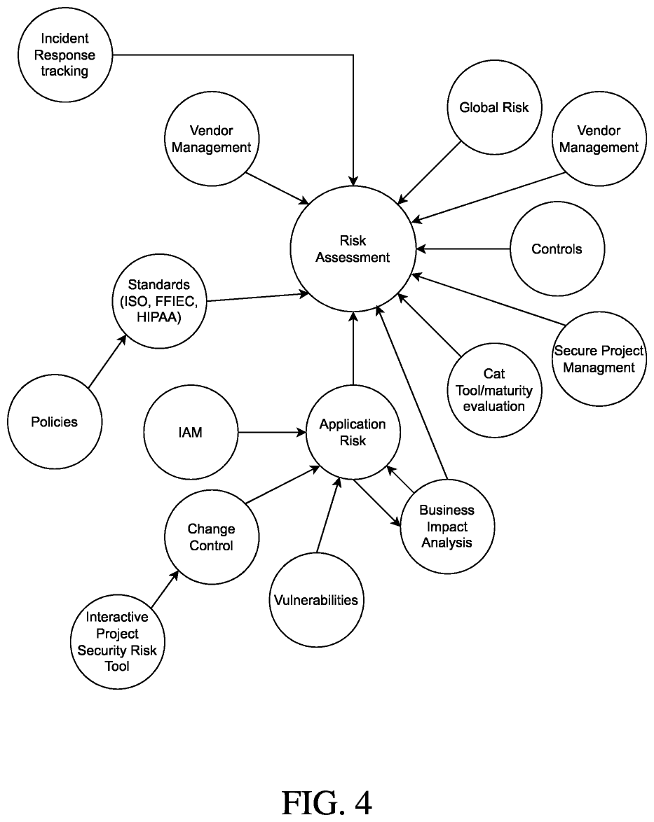

FIG. 4 shows the relationship of data in the model of Embodiment 2 of the present invention.

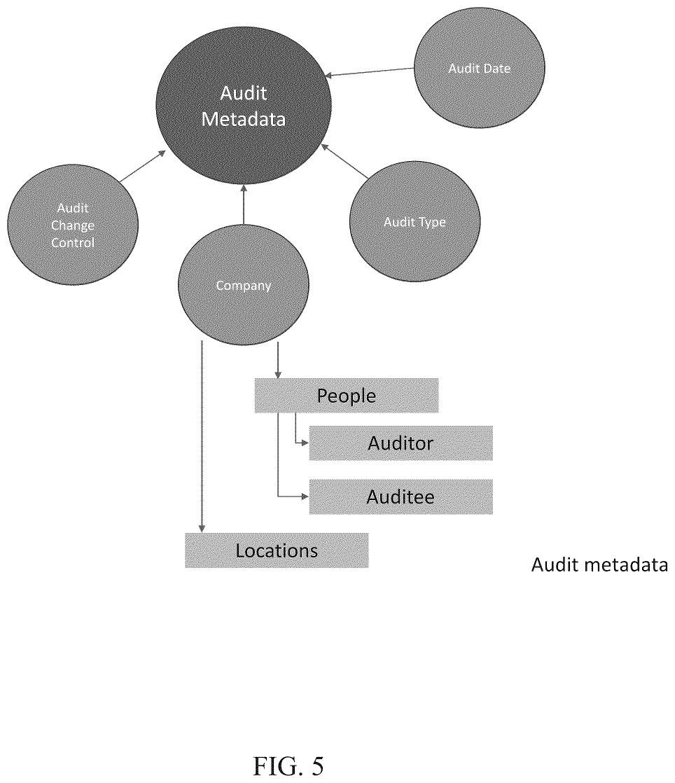

FIG. 5 shows the relationship of audit metadata of Embodiment 2 of the present invention.

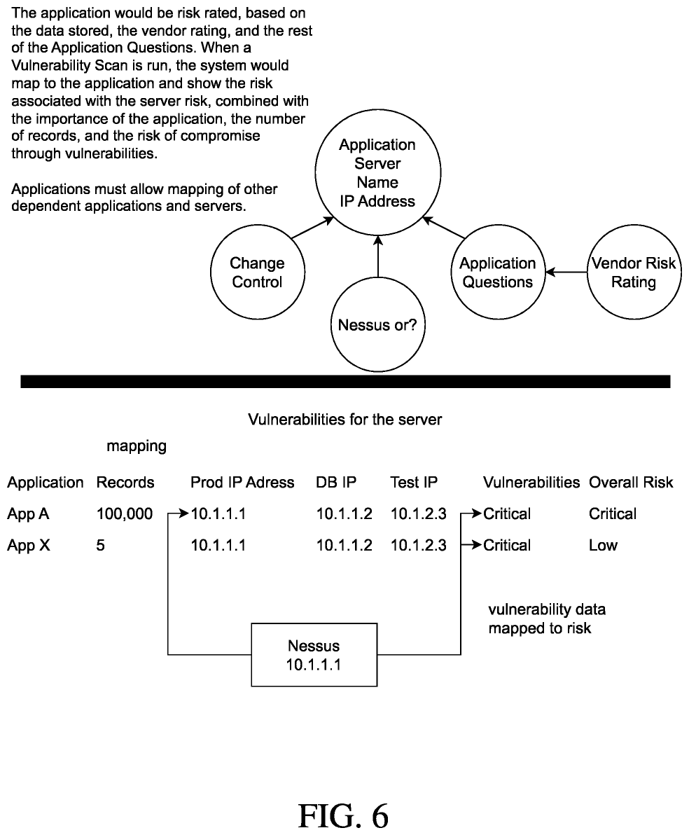

FIG. 6 shows the vulnerability data mapped to risk of Embodiment 2 of the present invention.

### Glossary of Terms

BIA: Business Impact Analysis.
CIACB: Confidentiality, Integrity, Availability, Compliance, and Business:
FFIEC: Federal Financial Institutions Examination Council
GRC: Governance, Risk, and Compliance.
HIPAA: Health Insurance Portability and Accountability Act.
IAM: Identity and Access Management.
ISO: International Organization for Standardization.
OS: Operating System.
SRT: Security Risk Tool.

Although the invention has been explained in relation to its preferred embodiment, it is to be understood that many other possible modifications and variations can be made without departing from the spirit and scope of the invention as hereinafter claimed. It is to be understood that the steps may be performed in any order, and steps may be repeated or omitted without departing from the spirit and scope of the invention. The questions and surveys will be modified, as necessary, to follow industry intelligence and security events.

1. A comprehensive method for risk assessment, the method comprising:
assessing global risk, wherein assessing global risk further comprises building a risk portfolio and assigning cost-benefit scores to one or more risks in the risk portfolio;
assessing application risk, wherein assessing application risk further comprises presenting a series of application risk questions and assigning an application risk score based on responses to the application risk questions;
managing vendors, wherein managing vendors further comprising minimizing an overlap of two or more vendor controls;
managing secure projects, wherein managing secure projects further comprises identifying concerns and implementing controls based on the identified concerns;
analyzing business impact, wherein analyzing business impact further comprises presenting a series of business impact questions and assigning a business impact risk score based on responses to the business impact questions; and
changing controls; wherein changing controls further comprises presenting one or more overall control options and altering one or more behaviors based on interactions with the one or more overall control options.

2. The method for risk assessment of claim 1, further comprising tracking incident response, wherein tracking incident response further comprises tracking an issue start time, an issue end time, and an issue summary.

3. The method for risk assessment of claim 1, further comprising evaluating maturity.

4. The method for risk assessment of claim 1, further comprising evaluating compliance with standards, wherein evaluating compliance further comprises presenting compliance evaluation questions and assigning a compliance score based on responses to the compliance evaluation questions.

5. The method for risk assessment of claim 1, wherein assessing application risk further comprises identifying vulnerabilities.

6. The method for risk assessment of claim 5, wherein identifying vulnerabilities further comprise scanning for vulnerabilities with a vulnerability tool.

7. The method for risk assessment of claim 1, wherein assessing application risk further comprises evaluating change control.

8. The method for risk assessment of claim 7, wherein evaluating change control further comprises operating an interactive project security risk tool.

9. The method for risk assessment of claim 1, further comprises generating audit metadata.

10. The method for risk assessment of claim 9, wherein the audit metadata further comprises:
an audit date; and
an audit type.

11. The method for risk assessment of claim 9, wherein the audit metadata further comprises audit change control metadata.

12. The method for risk assessment of claim 9, wherein the audit metadata further comprises company metadata.

13. The method for risk assessment of claim 12, wherein the company metadata further comprises:
people metadata; and
location metadata

14. The method for risk assessment of claim 13, wherein the people metadata further comprises:
auditor metadata; and
auditee metadata.

15. The method for risk assessment of claim 1, wherein analyzing business impact further comprises:
presenting a series of business impact questions to an auditor;
receiving one or more responses to the series of business impact questions; and
analyzing the one or more responses to the series of business impact questions.

16. A comprehensive system for risk management, comprising:
at least one non-transitory computer-readable medium configured to store instructions; and
at least one processor configured to execute the instructions to perform operations, the operations comprising:
assessing global risk, wherein assessing global risk further comprises building a risk portfolio and assigning cost-benefit scores to one or more risks in the risk portfolio;
assessing application risk, wherein assessing application risk further comprises presenting a series of application risk questions and assigning an application risk score based on responses to the application risk questions;
managing vendors, wherein managing vendors further comprising minimizing an overlap of two or more vendor controls;
managing secure projects, wherein managing secure projects further comprises identifying concerns and implementing controls based on the identified concerns;
analyzing business impact, wherein analyzing business impact further comprises presenting a series of business impact questions and assigning a business impact risk score based on responses to the business impact questions; and
changing controls; wherein changing controls further comprises presenting one or more overall control options and altering one or more behaviors based on interactions with the one or more overall control options.

17. The comprehensive system for risk management of claim 16, the instructions further comprising:
tracking incident response, wherein tracking incident response further comprises tracking an issue start time, an issue end time, and an issue summary.

18. The comprehensive system for risk assessment of claim 16, the instructions further comprising:
evaluating compliance with standards, wherein evaluating compliance further comprises presenting compliance evaluation questions and assigning a compliance score based on responses to the compliance evaluation questions.

19. A non-transitory computer readable medium comprising instructions, which when executed by at least one processor, cause the at least one processor to perform operations for comprehensive risk management, the operations comprising:
assessing global risk, wherein assessing global risk further comprises building a risk portfolio and assigning cost-benefit scores to one or more risks in the risk portfolio;
assessing application risk, wherein assessing application risk further comprises presenting a series of application risk questions and assigning an application risk score based on responses to the application risk questions;
managing vendors, wherein managing vendors further comprising minimizing an overlap of two or more vendor controls;
managing secure projects, wherein managing secure projects further comprises identifying concerns and implementing controls based on the identified concerns;
analyzing business impact, wherein analyzing business impact further comprises presenting a series of business impact questions and assigning a business impact risk score based on responses to the business impact questions; and
changing controls; wherein changing controls further comprises presenting one or more overall control options and altering one or more behaviors based on interactions with the one or more overall control options.

20. The non-transitory computer readable medium as claimed in claim 19, the operations further comprising:
tracking incident response, wherein tracking incident response further comprises tracking an issue start time, an issue end time, and an issue summary.
